(19) United States
(12) Patent Application Publication
(10) Pub. No.: US 2007/0218293 A1
(43) Pub. Date: Sep. 20, 2007

(54) LIGHT-REFLECTING SHEET AND SHAPED ARTICLE THEREOF

(75) Inventors: Hiroshi Kawato, Chiba (JP); Masami Kogure, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/575,348

(22) PCT Filed: Sep. 13, 2005
(86) PCT No.: PCT/JP05/16853

§ 371 Date: Mar. 15, 2007

(30) Foreign Application Priority Data
Sep. 15, 2004 (JP) 2004-268666

(51) Int. Cl. B32B 27/00

(52) U.S. Cl. 428/412

(57) ABSTRACT

The present invention provides a thin light-reflecting sheet with excellent light property of flame retardancy, a high light-reflectance and a high light-shielding ability, which is formed from a polycarbonate resin composition containing a combination of 70% to 30% by mass of a polycarbonate-based polymer (A) and 30% to 70% by mass of titanium oxide (B) having a difference of moisture concentration at 100° C. with that at 300° C. of 2700 ppm by mass or less. The invention also provides a shaped article thereof.

### TECHNICAL FIELD

The present invention relates to a light-reflecting sheet and a shaped article thereof. More specifically, the present invention relates to a thin sheet and a shaped article having excellent flame retardancy and light-reflecting property obtained from a polycarbonate resin composition.

### BACKGROUND ART

Generally, applications of a light-reflecting material include, sign boards, displays, liquid display backlight systems and the like. A conventional light-reflecting sheet used includes a metal plate, a metal foil laminated plastic sheet, a metal deposited plastic sheet, a foamed stretched PET film and the like, but has such problems as little freedom in selecting a shape in molding and higher cost in process such as bending or others

In recent years many technologies have also been proposed for light reflecting materials. Such technologies include blending with particularly surface-treated titanium oxide (for example, refer to Patent Documents 1 to 3), blending with a particular inorganic filler (for example, refer to Patent Document 4), blending with other polymers (for example, refer to Patent Documents 5 to 9), a combination with a foam product for light reflecting materials, and others, utilizing excellent mechanical properties (especially impact resistance), electrical properties, transparency, flame retardancy, dimensional stability, and heat resistance of a polycarbonate resin.

However, such light-reflecting materials using these polycarbonate resin have been mainly studied in the field of injection-molded articles, while study has been insufficient on a thermoformable sheet, which requires thin wall, weight reduction and area expansion in using for a backlight reflection plate of liquid crystal displays or other.

Furthermore, when a polycarbonate resin composition is used for an extruded sheet-shaped article, a high concentration of titanium oxide has to be contained since not only a high light reflectance but also a high light shielding are requested as the optical properties in light-reflecting applications such as backlight reflecting panels of liquid crystal displays. However, titanium oxide admixed in high concentration causes degradation of the polycarbonate resin matrix, thereby causing a problem of lowering light reflectance in shaped articles of the resin.

When a large volume of titanium oxide is combined, severer reduction in the molecular weight of polycarbonate is caused, thereby inevitably lowering mechanical strength. Even though there has been proposed a polycarbonate resin composition that is admixed with titanium oxide, has mechanical properties good enough for improving the above problems, and is excellent in optical properties (for example, refer to Patent Document 10), these properties have to be further improved in order to satisfy such requests from the market as requested in the backlight reflecting panels of liquid crystal displays, and others.

Furthermore, the polycarbonate resin admixed with a large amount of titanium oxide has the problem of easily having such failures as draw resonance, surface roughening and sticking to rolls in sheet extrusion and foaming and uneven thickness in thermoforming during the production of sheet and article, and the necessity of establishing a method to improve the above problem has been more and more increased toward thin wall, weight reduction and area expansion in a light-reflecting sheet and board of liquid crystal displays.

A polycarbonate resin has a high limiting oxygen index among various kinds of thermoplastic resins and is generally considered as a self-extinguishing resin. It is generally known that a polycarbonate-polyorganosiloxane copolymer or a mixture of a polycarbonate-polyorganosiloxane copolymer and polycarbonate resin shows higher flame retardancy than a polycarbonate resin. However, the level of flame retardancy required in the field of light reflection is generally as high as the level of V-0 in a UL94 standard for flame retardancy, so that more flame retarding agent and flame retarding auxiliary agent are added in order to give and satisfy this level of fire retardancy (for example, refer to Patent Document 11). In addition, it is generally considered to be difficult to satisfy both flame retardancy and high light reflection in a thin wall shaped article 0.6 mm thick or less, which is required in backlight reflecting panels of liquid crystal displays and others.

It has been then asked to improve a thermoformable thin wall sheet with uniform thickness, a thermoformed article and a manufacturing method using a polycarbonate resin composition which exhibits not only flame retardancy without adding phosphorous type flame retardants or halogen type flame retardant while maintaining the heat resistance but also the excellent light-reflecting property satisfying high light reflectance and high light-shielding.

Patent Document 1: Japanese Patent Laid-Open Publication No. Hei 06-207092

Patent Document 2: Japanese Patent Laid-Open Publication No. Hei 09-316314

Patent Document 3: Japanese Patent Laid-Open Publication No Hei 09-316315

Patent Document 4: Japanese Patent Laid-Open Publication No. Hei 07-242810

Patent Document 5: Japanese Patent Laid-Open Publication No. Hei 07-242781

Patent Document 6: Japanese Patent Laid-Open Publication No. Hei 07-242804

Patent Document 7: Japanese Patent Laid-Open Publication No. Hei 08-12869

Patent Document 8: Japanese Patent Laid-Open Publication No. 2000-302959

Patent Document 9: Japanese Patent Laid-Open Publication No. 2002-12757

Patent Document 10: Japanese Patent Laid-Open Publication No. Hei 05-320519

Patent Document 11: Japanese Patent Laid-Open Publication No. 2004-149623.

### DISCLOSURE OF THE INVENTION

It is an object of the present invention to provide a thin, light-reflecting sheet and a shaped article with flame retardancy and excellent light reflecting properties of high light reflectance and high light shielding using a polycarbonate resin composition which solves the problems of the aforementioned conventional technology.

In view of the above circumstances, the present inventors have made an intensive study and found that a polycarbonate resin composition containing specific titanium oxide can solve the above-described problems. The present invention has been completed based on this finding.

That is, the present invention provides the following:

(1) A light-reflecting sheet comprising a polycarbonate resin composition which contains a combination of 70% to 30% by mass of a polycarbonate-based polymer (A) and 30% to 70% by mass of titanium oxide (B) having a difference of moisture concentration at 100° C. with that at 300° C. to be 2700 ppm by mass or less when determined by the Karl Fisher's method.

(2) A light-reflecting sheet described above in (1), wherein the above polycarbonate resin composition further contains 0 to 1.0 part by mass of polytetrafluoroethylene (C) capable of forming fibrils and 0.01 to 5.0 parts by mass of a reactive polyorganosiloxane (D) with respect to 100 parts by mass of said resin composition.

(3) A light-reflecting sheet described above in (1) or (2), wherein the polycarbonate resin composition used in molding has a moisture concentration of 2850 ppm by mass or less,

(4) A light-reflecting sheet described above in (1) to (3), wherein a difference of the water concentration at 100° C. with that of 300° C. derived from titanium oxide (B) determined by the Karl Fishers method is 2700 ppm by mass or less in the above polycarbonate resin composition;

(5) A light-reflecting sheet described above in (1) to (4), having a thickness of 0.1 to 1 mm, a light reflectance of 99% or more, and a light transmittance of less than 1%.

(6) A light-reflecting sheet described above in (1) to (5), having flame retardancy of the V-0 class at a thickness of 0.6 mm in Vertical Timing Test complying with a UL94 method.

(7) A light-reflecting sheet described above in (1) to (6), having a coated layer formed on the surface of particle of titanium oxide (B) with a surface treating agent selected from a combination of any two or more of a hydrated oxide of aluminum and/or silicon, a phosphoric acid compound or its hydrates, a hydrolysate of an organic silane compound, and a reactive polyorganosiloxane.

(8) A light-reflecting sheet described above in (1) to (7), wherein a light-shielding layer is formed on the back thereof, and

(9) a shaped article characterized in that the light-reflecting sheet described above in (1) to (8) is heated at 160 to 200° C. to thermoform at a draw ratio of 1.1 to 2.

### BRIEF DESCRIPTION OF DRAWINGS

FIG. 1 is a partial longitudinal cross-sectional view of the reflecting face of a molded reflecting panel used in direct-underlying backlighting.

### DESCRIPTION OF THE SYMBOLS

1: Light-reflecting panel
2: Light-source accommodating groove
3: Mmnulticurved face
4: Curved section

### BEST MODE FOR CARRYING OUT THE INVENTION

Hereinafter, the present invention will be explained in detail. A preferred polycarbonate resin composition used in the present invention is composed of, on the basis of 100 parts by mass of (A)+(B),

(A) 70% to 30% by mass of a polycarbonate-based polymer,

(B) 30% to 70% by mass of titanium oxide,

(C) 0 to 1.0 part by mass of polytetrafluoroethylene capable of forming fibrils, and

(D) 0.01 to 5 parts by mass of a reactive polyorganosiloxane.

The polycarbonate-based polymer component (A) is preferably a mixture of a polycarbonate-polyorganosiloxane copolymer (A-1) and a polycarbonate resin (A-2).

As (A-1) component, there are various polycarbonate-polyorganosiloxane copolymers (hereinafter, referred to PC-PDMS copolymer in some cases), which are preferably composed of a polycarbonate portion and a polyorganosiloxane portion.

The polycarbonate portion has the repeating unit represented by following general formula (1), 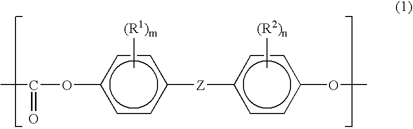
wherein in the formula, R¹ and R² each is a halogen atom such as chlorine, fluorine, or iodine, or an alkyl group having 1 to 8 carbon atoms such as methyl group, ethyl group propyl group, isopropyl group, any isomers of butyl groups including n-butyl group, isobutyl group, sec-butyl group, and tert-butyl group, various isomers of pentyl groups, various kind of heptyl groups, and various kinds of octyl groups; m and n each is an integer of 0 to 4 and when m is 2 to 4, R¹ may be the same or different, whereas when n is 2 to 4, R² may be the same or different; and Z is an a kylene group having 1 to 8 carbon atoms or an alkylidene group having 2 to 8 carbon atoms such as methylene group, ethylene group, propylene group, butylene group, pentylene group, hexylene group, ethylidene group, isopropylidene group, etc., a cycloalkylene group having 5 to 15 carbon atoms or a cycloalkylidene group having 5 to 15 carbon atoms such as cyclopentylene group, cyclohexylene group cyclopentylidene group, cyclohexylidene group, etc., —SO₂— —SO—, —S—, —O—, or —CO— linkage, or a linkage represented by following formula (2) or formula (2′).

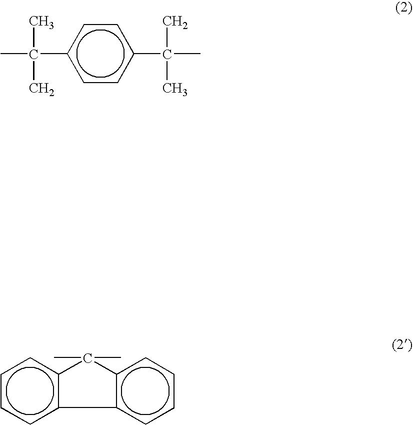

The polyorganosiloxane portion has a repeating unit of the structure represented by following general formula (3), 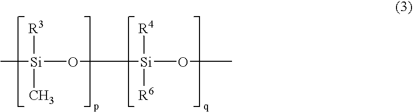
wherein in the formula, R³, R⁴ and R⁵ each is a hydrogen atom, an alkyl group having 1 to 5 carbon atoms such as methyl group, ethyl group, propyl group, n-butyl group, isobutyl group, etc., or phenyl group and p and q each is 0 or an integer of 1 or higher.

The polymerization degree of the polycarbonate portion is preferably from 3 to 100, whereas that of the polyorganosiloxane portion is preferably from 2 to 50.

The above-described PC-PDMS copolymer is a block copolymer consisting of the polycarbonate portion having the repeating unit represented by the above formula (1) and the polyorganosiloxane portion having the repeating unit represented by above formula (3) and has a viscosity average molecular weight of preferably from 10,000 to 40,000, more preferably from 12,000 to 35,000. Such PC-PDMS copolymer can be produced, for example, as follows: polycarbonate oligomer (hereinafter abbreviated as PC oligomer) prepared in advance, which will form the polycarbonate portion, and a polyorganosiloxane (for example, a polydialkylsiloxane such as polydimethylsiloxane (PDMS) or polydiethylsiloxane, or polymethylphenylsiloxane, etc.) having a reactive end group, which will form the polyorganosiloxane portion, are dissolved in a solvent such as methylene chloride, chlorobenzene, chloroform, etc; to the resulting solution, a sodium hydroxide aqueous solution containing bisphenol is added; and interfacial polycondensation is conducted using a catalyst such as triethylamine and trimethylbenzylammonium chloride.

A PC-PDMS copolymer, which is produced by the method, described in Japanese Patent Application Publication No. Shou 44-30105 and Japanese Patent Application Publication No. Shou 45-2051 may be also used.

The PC oligomer having the repeating unit represented by general formula (1) can be easily produced using the solvent method, that is, by reacting a dihydric phenol represented by following general formula (4) and a carbonate precursor such as phosgene and a carbonate compound in a solvent such as methylene chloride, etc. in the presence of a known acid scavenger or molecular weight regulator, 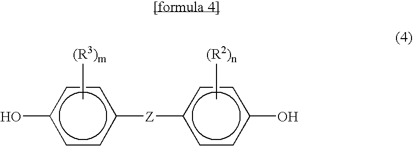
wherein in the formula, R¹, R², Z, m, and n are the same as in above general formula (1).

That is, they are produced, for example, by the reaction between a dihydric phenol and a carbonate precursor such as phosgene in a solvent such as methylene chloride etc. in the presence of a known acid scavenger and a molecular weight regulator or by the ester-exchange reaction between a dihydric phenol and a carbonate precursor such as diphenyl carbonate.

There are various dihydric phenols represented by general formula (4), but 2,2-bis(4-hydroxyphenyl)propane [bisphenol A] is preferred. Dihydric phenols other than bisphenol A include a bis(4-hydroxyphenyl)alkane other than bisphenol A such as 1, 1-(4-hydroxyphenyl)methane and 1,1-(4-hydroxyphenyl)ethane, 4,4′-dihydroxydiphenyl, a bis(4-hydroxyphenyl)cycloalkane, bis(4-hydroxyphenyl) oxide, bis(4-hydroxyphenyl) sulfide, bis(4-hydroxyphenyl) sulfone, bis(4-hydroxyphenyl) sulfoxide, bis(4-hydroxyphenyl) ketone, and others. Besides these dihydric phenols, hydroquinone and others may be included. These dihydric phenols each can be used singly or in combination of two or more.

The carbonate compounds include, a diaryl carbonate such as diphenyl carbonate, etc. and a dialkyl carbonate such as dimethyl carbonate, diethyl carbonate, etc. Various molecular weight regulators can be used and may include the one generally used in polymerization of polycarbonate. Specifically, a monohydric phenol includes, for example, phenol, p-cresol, p-tert-butylphenol, p-ert-octylphenol, p-cumylphenol, nonylphenlol, and others.

In the present invention, the PC oligomer used for the production of the PC-PDMS copolymer may be a homopolymer using one kind of the aforementioned dihydric phenols or a copolymer using two or more kinds of them. Furthermore, they may be a thermoplastic random-branched polycarbonate, which is obtained by combining a polyfunctional aromatic compound with the aforementioned dihydric phenol.

In order to produce a PC-PDMS copolymer having a n-hexane soluble fraction of 1.0% by mass or less, the above-described copolymerization is preferably carried out, for example, by reducing a polyorganosiloxane content in the copolymer to 10% by mass or less as well as using the polyorganosiloxane represented by general formula (3) having the number of repeating unit of 100 or more and a catalyst such as a tertiary amine at 5.3×10⁻³ mole/(kg of oligomer) or more.

A polycarbonate resin of (A-2) component comprising the polycarbonate resin composition of the present invention can be readily produced, though not particularly limited to, by reacting a dihydric phenol and phosgene or a carbonate compound.

That is, they are produced, for example, by the reaction of a dihydric phenol with a carbonate precursor such as phosgene in a solvent such as methylene chloride, etc. in the presence of a known acid scavenger and a molecular weight regulator or by the ester-exchange reaction between a dihydric phenol and a carbonate precursor such as diphenyl carbonate. The dihydric phenol herein may be the same as or different from the compound represented by above general formula (4).

They may be a homopolymer using one kind of the aforementioned dihydric phenols or a copolymer using two or more kinds of them. Further, they may be a thermoplastic random-branched polycarbonate which is obtained by combining a polyfunctional aromatic compound with the aforementioned dihydric phenol.

The example of the carbonate compound includes a diaryl carbonate such as diphenyl carbonate, etc. and a dialkyl carbonate such as dimethyl carbonate, diethyl carbonate, etc. The molecular weight regulators include various ones generally used in the polymerization of polycarbonate as is the above case.

Specifically, monohydric phenols include, for example phenol, p-cresol, p-tert-butylphenol, p-ert-octylphenol, p-cumylphenol, nonylphenol, and others.

Among component (A), a mixing ratio of component (A-1) is from 30 to 70 parts by mass, preferably from 35 to 50 parts by mass and that of component (A-2) is from 0 to 40 parts by mass, preferably from 10 to 30 parts by mass with respect to 100 parts by mass of the total amount of each component (A)+(B). When component (A-1) is 30 parts by mass or more, dispersion of the polyorganosiloxane is good, whereas when components (A-1) and (A-2) are within the preferable range, good flame retardancy can be achieved. The content of the polyorganosiloxane moiety in the PC-PDMS is properly selected to match the level of flame retardancy requested for the final resin composition.

A ratio of the polyorganosiloxane moiety in component (A-1) is preferably from 0.3 to 10% by mass, more preferably from 0.5 to 5% by mass based on the total amount of components (A-1) and (A-2). When a ratio is 0.3% by mass or more, an limiting oxygen index is assured to exhibit the objective flame retardancy. When a ratio is 10% by mass or less, the heat resistance of the resin is assured and a cost increase of the resin can be suppressed. Within the preferable range, more suitable limiting oxygen index and excellent flame retardancy can be obtained.

“Polyorganosiloxane” herein does not include but excludes the polyorganosiloxane component which is included in the organosiloxane of component (D).

Titanium oxide as component (B) of the present invention is used in a form of fine powder to provide a high reflectancy and low transparency that is, high light-shielding to polycarbonate resin. Titanium oxide fine particles with various particle sizes can be produced using any method of the chlorination and sulfuric acid methods. The titanium oxide used in the present invention may be either rutile or anatase, but rutile type is preferable in view of thermal stability and weatherability.

Further, the particle shape of the fine powder is not limited and may be properly selected and used from a scale-like, spherical, and amorphous shape.

As the titanium oxide of component (B) in the present invention, there is used titanium oxide which has a difference of the moisture concentration at 100° C. with that of 300° C. to be 2700 ppm by mass or less, preferably 2600 ppm by mass or less determined by the Karl Fischer's method. When the moisture concentration difference of the above titanium oxide is 2700 ppm by mass or less, the hydrolysis degradation of polycarbonate resin with water can be reduced in dispersing in the polycarbonate resin at a high concentration upon melt-kneading, thereby improving uniform ity of the dispersion and stability of the dispersed state in the polycarbonate resin composition as well as improving the affinity to the flame retardant to be added to yield a uniform resin composition.

Furthermore, in the kneading extrusion process, a back flow (backpressure) of the water vapor pressure to the hopper side caused by the water vapor generated from the titanium oxide can be reduced; therefore, the ingredient powder can be stably fed, giving stable product quality, which is preferred in production processes.

Such titanium oxide preferably includes the one which has a coating layer formed with a surface treatment agent selected from a combination of any two or more of a hydrated oxide of aluminum and/or silicon, a phosphoric acid compound or its hydrates, a hydrolysate of an organic silane compound, and a reactive polyorganosiloxane.

In the present invention, one kind, two or more of the titanium oxide of component (B) can be preferably used so far as a difference of the moisture concentration at 100° C. with that at 300° C. determined by the Karl Fisher's method is 2700 ppm by mass or less.

The moisture concentration at 100° C. and 300° C. determined by the Karl Fisher's method are measured in accordance with the method described below.

After the sample titanium dioxide powder is left under constant temperature and humidity at a temperature of 25° C. and a relative humidity of 55% for 24 hrs to reach an equilibrium state, 0.3 g of such sample is used to measure at 100° C. and 300° C. under a nitrogen gas flow of about 250 mL using a Karl Fisher moisture titrator of “Coulometric Moisture Analyzer CA100” and a moisture evaporator of “VA-100” attached to it (both from DIA Instruments Co. Ltd).

The aforementioned hydrated oxide of aluminum and/or silicon is the publicly known one, which is used for treating the titanium oxide commercially available for a pigment to inhibit the photocatalytic activity thereof.

As the phosphoric acid compound aluminum phosphate (AlPO₄) or hydrate thereof is preferred and may be used in combination with the hydrated oxide of aluminum and/or silicon.

As the hydrolysates of organic silane compounds, an organic silane compound having general formula (5) or general formula (6) is preferably used.
R⁶n-Si—(OR⁷)₄₋ₙ (5)
wherein in the formula, R⁶ is a hydrocarbon group having 10 or less carbon atoms including at least one kind of an alkyl group, vinyl group, or methacryl group, R⁷ is a methyl or ethyl group and n is an integer of 1 to 3, but when n is 2 or 3, R can be the same or different kinds of hydrocarbon groups. 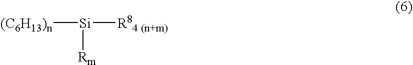
wherein R is an alkyl group having 5 or less carbon atoms R⁸ is a hydrolysable group and n is 1 to 3, m is 0 to 2 and an, integer satisfying n+m≦3

The reactive polyorganosiloxane to coat the surface of titanium oxide particles is used to prevent degradation of the resin and keep such properties of the resin as mechanical strength, stability and heat resistance. Specifically it includes an alkylhydrogensilicone an alkoxysilicone and others. The alkylhydrogensilicone includes, for example, methylhydrogensilicone, ethylhydrogensilicone, and others. When a moisture content of the titanium oxide is high, methylhydrogensilicone self-condenses vigorously to cause a problem that the surface of titanium oxide is not coated effectively with methylhydrogensilicone, but in the case of the titanium oxide with moisture content reduced in the present invention, methylhydrogensilicone can be preferably applied. The alkoxysilicone includes for example, methoxysilicone, ethoxysilicone, and others. A preferable a koxysilicone is specifically a silicone compound having an alkoxysilyl group, of which an alkoxy group is bonded directly or via a divalent hydrocarbon group with a silicon atom, and includes, for example, straight-chain, ring, network, and partly branched straight-chain organopolysiloxanes and a straight-chain organopolysiloxane is particularly preferred. More specifically, a polyorganosiloxane having a molecular structure in which an alkoxy group is bonded to the silicone main chain through a methylene chain is preferable.

Preferred reactive polyorganosiloxanes include, for example, commercially available SH1107, SR2402, BY16-160, BY16-161, BY16-160E, BY16-161E, and others from Dow Corning Toray Co., Ltd.

In the aforementioned surface treatment, the treatment method itself is not particularly limited and any method is used as appropriate. An amount of the surface treatment agent applied to the surface of titanium oxide particles in this process is not particularly limited but appropriately in a range of 0.1 to 10% by mass with respect to the titanium oxide in view of the light-reflecting property of the titanium oxide and the moldability of the polycarbonate resin composition.

In the present invention, the aforementioned surface treating agent can be used singly or in combination of two or more kinds, but preferably in combination of two or more kinds.

As the titanium oxide with the difference of moisture concentration at 2700 ppm by mass or less determined by the Karl Fisher's method described above, commercially available products can be used. For example, PF740. PFC303 and others from Ishihara Sangyo Kaisha, Ltd. can be preferably used.

In the composition of the present invention, a particle diameter of the aforementioned titanium oxide powder used as component (B) is not particularly limited, but an average particle diameter is preferably about 0.1 to about 0.5 μm in order to exhibit the above effect efficiently. The mixing amount of the titanium oxide in the polycarbonate resin composition of the present invention is from 30 to 70 parts by mass, preferably from 35 to 70 parts by mass with respect to 100 parts by mass of the total amount of each component of (A)+(B). When a mixing amount is 30 parts by mass or more, sufficient light-shielding and light reflectance can be assured.

When the mixing amount of the titanium oxide used in the present invention is 70 parts by mass or less, polymer pelletization by kneading extrusion and a molding process of the resin can be easier, and surface roughening (voids and blisters) tends to reduce. In particular, the mixing amount of component (B) is more preferably from 35 to 60 parts by mass, since the light-reflecting panels or frames used in the backlight system of liquid crystal TVs, monitors, and others require the light shielding and high light reflectance.

Next, polytetrafluoroethylene (hereinafter abbreviated as “PTFE” in some cases) capable of forming fibrils as component (C) of the polycarbonate resin composition, optionally can provide an antidripping effect on melt and a high flame retardancy as needed. The weight average molecular weight is preferably 500,000 or more, more preferably from 500,000 to, 10,000,000, further more preferably from 1,000,000 to 10,000,000.

An amount of component (C) is from 0 to 1.0 part by mass, preferably from 0.1 to 0.5 part by mass with respect to the total amount of 100 parts by mass of component (A) and component (B). By specifying the amount of component (C) within the above range, impact resistance and excellent appearance of a shaped article can be obtained, and also pulsation of strands output in kneading extrusion can be prevented to stably run the production of pellets. Within the preferable range, a preferred antidripping effect on melt and excellent flame retardancy can be obtained.

The polytetrafluoroethylene (PTFE) as component (C) capable of forming fibrils is not particularly limited, but for example, the PTFE classified in Type 3 in accordance with the ASTM standard can be used. Such PTFE classified in this type specifically includes “Teflon 6-J” (trade names from DuPont-Mitsui Fluorochemicals Co., Ltd.), “Polyflon D-1 and Polyflon F-103” (trade name from Daikin Industries, Ltd.) and others. Besides Type 3 products, there can be listed “Algoflon F5” (trade name, from Moontefluos SPA), “Polyflon MPA FA-100” (trade name, from Daikin Industries, Ltd.) and others. These PTFEs can be used in combination of two or more kinds.

The aforementioned PTFE having a capability of forming fibrils can be obtained, for example, by polymerizing tetrafluoroethylene in an aqueous solvent in the presence of sodium, potassium, or ammonium peroxydisulfide under a pressure of 0.007 to 0.7 MPa at a temperature of 0 to 200° C., preferably 20 to 100° C.

The organosiloxane as component (D) of the polycarbonate resin composition of the present invention is admixed in order to prevent degradation of the resin and keep such properties as mechanical strength, stability and heat resistance of the resin and specifically includes an alkylhydrogensilicone and an alkoxysilicone.

The alkylhydrogensilicone includes, for example, methylhydrogensilicone, ethylhydrogensilicone, and others. The alkoxysilicone includes, for example, methoxysilicone, ethoxysilicone, and others.

A particularly preferable a koxysilicone is, specifically, a silicone compound having a alkoxysilyl group, of which the alkoxy group is bonded to the silicon atom directly or through a divalent hydrocarbon group, and includes, for example, a straight-chain, ring, network, and a partly branched straight-chain organopolysiloxane, and a straight-chain organopolysiloxane is particularly preferable. More specifically, a organopolysiloxane having such a molecular structure, in which an alkoxy group is bonded to the silicone main chain through a methylene chain is preferable.

The organosiloxane of component (D) preferably used include, for example, commercially available SH1107, SR2402, BY16-060, BY16-161, BY16-160E, BY16-161E, and others from Dow Corning Toray Co., Ltd.

In the present invention, when the titanium oxide having a difference of a Karl Fisher moisture content of 2700 ppm by mass or less between 100° C. and 300° C. is used and the surface treatment of the reactive polyorganosiloxane is pre-applied to form a surface coating layer of the titanium oxide, the adding amount of the organosiloxane of component (D) is preferably in a range of 0.01 to 3.0 parts by mass with respect to 100 parts by mass of the total amount of each component of (A)+(B), depending on the amount of titanium oxide added. By specifying such amount of the organosiloxane within the above range, degradation of the polycarbonate resin can be prevented, and lowering of the molecular weight of the resin can also be suppressed and generation of voids and blisters on the surface of a shaped article is reduced to economically yield a product having an excellent appearance.

The polycarbonate resin composition used in the present invention can be optionally admixed with various kinds of flame retardants, inorganic fillers, additives, other synthetic resins) elastomers, and others within a range not impairing a purpose of the present invention and as needed besides each component of aforementioned (A) (B), (C), and (D). As the flame retardant, there can be listed a phosphorous compound and a bromine compound. Although the composition used in the present invention can assure sufficient flame retardancy by combining the polycarbonate-polyorganosiloxane copolymer of component (A-1) and the polycarbonate resin of component (A-2), the flame retardants include phosphorous type compounds and bromine type compounds and can be used in a range of less than 0.5 parts by mass, preferably 0.3 parts by mass or less with respect to 100 parts by mass of the components (A)+(B) as needed when higher flame retardancy is requested.

When a phosphorous type compound is added as a flame retardant, there is a problem, that is, a decrease in the light reflectance and heat resistance of the sheet while the flowability is improved. On the other hand, when a bromine type compound is used as a flame retardant, there is a disadvantage that the thermal stability is generally reduced.

The phosphorous type compound as a flame retardant preferably includes a phosphate compound.

The specific examples include trimethyl phosphate, triethyl phosphate, tributyl phosphate, trioctyl phosphate, tributoxyethyl phosphate, triphenyl phosphate, tricresyl phosphate, cresyl diphenyl phosphate, octyl diphenyl phosphate, tri(2-ethylhexyl) phosphate, diisopropyl phenyl phosphate, trixylenyl phosphate, tris(isopropylphenyl) phosphate, trinaphthyl phosphate, bisphenol A bisphosphate, hydroquinone bisphosphate, resorcin bisphosphate, resorcinol diphenyl phosphate, trihydroxybenzene triphosphate, and cresyl diphenyl phosphate, etc and further a compound thereof, into which various substituents are introduced, oligomers and polymers thereof. These phosphate compounds each can be used singly or in combination of two or more kinds.

The bromine type compounds as a flame retardant includes, for example, a brominated bisphenol A epoxy polymer, pentabromobenzyl acrylate, a brominated polycarbonate oligomer, a triazine-based flame retardant, tetrabromobisphenol A, bis(tribromophenoxy)ethane, tetrabromobisphenol A-bis(2-hydroxyethyl ether), tetrabromobisphenol A-bis(2,3-dibromopropyl ether) tetrabromobisphenol A-bis(allyl ether), hexabromocyclododecane, polydibromophenylene oxide, and brominated phthalate, etc. These bromine type compounds can be used singly or in combination of two or more kinds.

The inorganic fillers, which are admixed with a purpose to improve the mechanical strength, durability or a weight increase of the polycarbonate resin composition include, for example, glass fibers (GF), carbon fibers, glass beads, glass flakes, carbon black, calcium sulfate, calcium carbonate, calcium silicate, alumina, silica, asbestos, talc, clay, mica, and quartz powder, etc. The above additives include, for example, phosphorous type, hindered phenol type, or amine type antioxidants, for example, benzotriazole type or benzophenone type ultraviolet ray absorbers, for example, aliphatic carboxylate type, paraffin type, silicone oil, and polyethylene wax external lubricants, release agents, antistatic agents, coloring agents and others. Other synthetic resins include each resins of polyethylene, polypropylene, polystyrene, an AS resin (acrylonitrile-styrene copolymer), an AS resin (acrylonitrile-butadiene-sty ene copolymer), polymethyl methacrylate etc. The elastomers include an isobutylene-isoprene rubber, a styrene-butadiene rubber, an ethylene-propylene rubber, an acrylic elastomer, etc.

Hereinafter will be explained the method for producing the light-reflecting sheet of the present invention, thermoform g, producing shaped articles, and laminating with the other components using the above polycarbonate resin composition.

[Light-Reflecting Sheet]: The light-reflecting sheet of the present invention is produced using the aforementioned polycarbonate resin composition through following processes.

Drying process: The polycarbonate resin composition is dried in a range of about 120 to about 140° C. for about 2 to about 10 hrs. The drying condition for the material herein is preferably at 130 to 140° C. for 2 to 10 hrs, more preferably at 130 to 140° C. for 4 to 10 hrs.

The polycarbonate resin composition can be dried under an atmospheric condition of heated air, dry air, vacuum or others. Such drying process can remove most of moisture contained in the material and the volatile reaction byproducts generated in preparation of the composite.

Extrusion process: The material is extruded into a specific shape with an extruder equipped with a devolatilizer. The devolatilizer of extrusion equipment to mold a light-reflecting sheet ca reduce the pressure below an atmospheric pressure in a melt condition and lowers the pressure generally at 8 kPa or less, preferably at 4 kPa or less on extrusion.

Such devolatilization under reduced pressure allows removal of a moisture remained in the material and secondary volatile reaction byproducts generated in the extrusion molding.

If drying of the material and devolatilization in extrusion molding are not sufficient, the sheet tends to foam or roughen the surface so that the light reflectance tends to lower or the light reflection tends to be irregular.

For these reasons, the moisture concentration in the polycarbonate resin composition supplied for molding is preferably 2850 ppm by mass or less, particularly preferably 2700 ppm by mass or less.

The moisture concentration in the said composition can be measured in the similar manner and condition as those for the measurement of the moisture content in the titanium oxide. An amount of the sample is, however, 0.7 g.

Sheet molding process: Subsequently a sheet is molded at a die temperature in a range of about 200 to about 260° C. and a roll temperature in a range of about 120 to about 180° C.

The die temperature is herein in a range of about 200 to about 260° C., preferably 200 to 250° C., more preferably 200 to 240° C. When the die temperature exceeds 260° C., draw resonance phenomenon easily occurs, as a result, causing an uneven sheet thickness in the width (especially at the edges) and longitudinal directions, and the light reflection tends to be irregular on the surface of the resulting sheet itself and the thermoformed article thereof. This phenomenon tends to occur in sheet molding of the material comprising a large amount of the titanium oxide used in the present invention.

Furthermore, a temperature of the cooling roll in sheet molding is in a range of about 120 to about 180° C., preferably in a range of about 120 to about 170° C. If the temperatures of all rolls are lower than 120° C., sizing between nip rolls become difficult because of high rigidity of the melt of the present material and the homogeneity of the sheet surface in the width and longitudinal directions is difficult to keep resulting in a reflection irregularity on the surface of the resulting sheet itself and the thermoformed article thereof.

When the temperatures of all the rolls exceed 170° C., sticking and adhesion to the roll cause surface adhesion, uneven release and warping of the sheet, failing to yield a light-reflecting panel having a uniform light-reflecting property as an object of the present invention

[Thermoforming]: Use of the aforementioned polycarbonate resin composition gives thermoformability to the light-reflecting sheet of the present invention, and under a particular thermoforming condition, allows production of a light-reflecting panel having a light-reflecting plane which matches with the number and shape of light-sources.

The sheet heating temperature (surface temperature of the sheet) in thermoforming is herein in a range of about 160 to about 200° C., preferable 170 to 200° C. while an average draw ratio is preferably from 1.2 to 2, more preferably from 1.2 to 1.8.

Also, a method of thermoforming used in the present invention is not particularly limited, but includes press molding, vacuum molding, air-compressed molding, hot-plate molding, corrugated molding and the like. The molding method commonly called as vacuum molding includes the method such as drape forming matched die molding, pressure bubble-plug assist vacuum forming, plug assist forming vacuum snapback forming, air-slip forming, trapped sheet-contact heat-pressure forming, and simple air-compressed molding. In general, vacuum molding is properly carried out at a pressure of 1 MPa or less.

When a sheet heating temperature is below 160° C., thermoforming becomes difficult, whereas when it exceeds 200° C., inhomogeneous surface roughness is easily developed on the surface of the sheet. Further when the draw ratio is less than 1.2, a light-reflecting panel matching with a shape of light-sources is not easily designed, whereas when the draw ratio exceeds 2, thickness of the thermoformed article is very uneven to readily generate irregularity in the light reflectance.

The sheet used for the present thermoforming is then preferably pre-dried to prevent a foaming phenomenon caused by water absorption. Such drying condition is preferably in a range of about 120 to about 140° C. for a range of about 2 to about 10

[Shaped Articles]: A proper adjustment of the above polycarbonate resin composition, a sheet production condition and a thermoforming condition can yield a shaped article of the present invention, of which the light ref ection plane has an uneven thickness of 0.05 mm or less. When the uneven thickness exceeds 0.05 mm, a uniform surface reflection property is not attained. A shape of the shaped article can also be properly selected in accordance with the shape, number, and property of light-sources.

For example in the case of a light-reflecting panel for the direct-underlying backlight of liquid crystal displays, the shape disclosed in Japanese Patent Laid-Open Publication No. 2000-260213, Japanese Patent Laid-Open Publication No. 2000-356959, Japanese Patent Laid-Open Publication No. 2001-297613, and Japanese Patent Laid-Open Publication No. 2002-32029 may be used.

[Lamination with the Other Components]: In the present invention, a sheet layer of the aforementioned polycarbonate resin composition can be laminated with another layer in accordance with an intended use so long as the light-reflecting property of the sheet layer is not disturbed.

For example, a layer of a light-shielding, flame-retardant polycarbonate resin can be laminated on the rear face of the light-reflecting plane. The thickness of the resin layer in this case is preferably 0.05 mm or less and the total light transmittance thereof is preferably 0.1% or less. A light-shielding material herein includes a metal such as a thin aluminum layer, and a paint and others, while a structure reinforcing layer includes a polycarbonate-based resin layer. In addition, a light-resisting layer can be set up on the light-reflecting plane. Such other layers can be laminated by a method such as coating, vapor deposition, extrusion lamination, dry lamination, co-extrusion and others. Furthermore, a metal layer such as aluminum foil, etc. car be set up for heat diffusion.

The light-reflecting sheet of the present invention can be obtained by combining the aforementioned polycarbonate resin composition with the above described method, of which at least one layer is composed of the polycarbonate composition, preferably has a thickness of 0.1 mm to 1 nm a light reflection of 99% or more, a light transmittance of less than 1% and flame retardancy of a V-0 class at a thickness of 0.6 mm in UL94 Vertical Burning Test and a thermoformability.

The thickness herein is preferably from 0.1 to 1 mm, more preferably from 0.2 to 0.8 mm, further more preferably from 0.3 to 0.6 mm Adjusting a thickness of the present sheet to the above range may prevent drawdown and uneven thickness when thermoforming a large-area light-reflecting panel. Furthermore, uneven in-plane light reflection can be inhibited and no temperature differences among the surface on one side, the inside, and the surface on the other side of the sheet in thermoforming take place. As a result, yielding a thermoformed article having a uniform light-reflecting property can be obtained.

The light reflectance is also preferably 99% or more, more preferably 99.3%, and further more preferably 99.5% or more. Such high light reflectance can be attained by adjusting the content of the titanium oxide.

Further, the light transmittance is preferably less than 1%, more preferably 0.8% or less, further more preferably 0.3% or less. Such sheet having excellent light-shielding can be attained by adjusting the content of the titanium oxide, the sheet thickness, and the good surface condition.

When a light reflectance is 99% or more or a light transmittance is less than 1, a sufficient luminance can be herein attained in the intended use of light reflection.

Further, the flame retardancy of a V-0 class at a thickness of 0.6 mm in UL94 Vertical Burning Test can enhance the flame retardancy for a light box.

In addition, the thermoformability makes it easy to design a shape to match with the type and number of light-sources and yields a light box having a high luminance and no irregularity.

### EXAMPLES

The present invention will be further explained in more detail with reference to the following examples, but is not limited to those examples.

Various methods to evaluate the sheets and thermoformed articles are carried out as follows.
(1) Thickness: The thickness of thermoformed articles was measured at sixteen points or more, and the standard deviation was calculated.
(2) Surface roughness: The surface of the sheet was visually inspected whether inhomogeneous and low gloss parts exist or not.
(3) Light reflectance: A Y-value was measured at a viewing angle of 10 degrees with a LCM2020 plus from Macbeth Corp. equipped with a D light source.
(4) Light transmittance: The total light transmittance was measured with 1001D from Nippon Denshoku Industries Co., Ltd.
(5) Flame retardancy. A vertical burning test (V-0 test) complying with UL94 was carried out.
(6) Plane reflection uniformity: A 15 inch direct-underlying backlight type light box having six cold-cathode tubes and a light diffusing panel was prepared, into which a thermoforming article was inserted as a light reflection plate to visually evaluate the homogeneity of luminance.

Evaluation Criteria
◯; Luminance is uniform in the plane.
X; High or low luminance sections are observed in spots.

### Production Example 1

[Production of PC Oligomer]

In 400 L of a 5% by mass sodium hydroxide aqueous solution was dissolved 60 kg of bisphenol A to prepare a sodium hydroxide aqueous solution of bisphenol A.

Next, the sodium hydroxide aqueous solution of bisphenol A kept at room temperature and methylene chloride were introduced at a flow rate of 1.38 L/hr and 69 L/hr, respectively through an orifice plate into a tube reactor with an inner diameter of 10 nm and a length of 10 m, into which phosgene was concurrently injected at a flow rate of 10.7 kg/hr to continuously react for 3 hrs.

The tube reactor used herein was double-tube, of which a jacket section was flown with cooling water to keep the temperature of the discharged reaction solution at 25° C. pH of the effluent was adjusted to 10 to 11.

The reaction solution thus obtained was left to stand to separate and discard the water phase and collect the methylene chloride phase (220 L), yielding a PC oligomer (concentration, 317 g/L). The PC oligomer obtained herein had a degree of polymerization of 2 to 4 and a concentration of the chloroformate group was 0.7 normal.

### Production Example 2

[Production of Reactive PDMS]

1,483 g of octamethylcyclotetrasiloxane, 96 g of 1,1,3,3-tetramethyldisiloxane, and 35 g of 86% by mass of sulfuric acid were mixed and stirred at room temperature for 17 hrs. The oil phase was then separated, to which 25 g of sodium hydrogen carbonate was added to stir for 1 hr. After filtration, the reaction mixture was vacuum-distilled at 150° C. under 3 Torr (4×10² Pa) to remove low-boiling products to yield an oil.

294 g of the oil obtained above was added to a mixture of 60 g of 2-allylphenol and platinum chloride-alcoholate complex in an amount of 0.0014 g in terms of platinum at 90° C. The mixture was stirred for 3 Ms while keeping the temperature at 90 to 115° C.

The product was extracted with methylene chloride, washed with 80% by mass aqueous methanol three times to remove excess 2-allylphenol. The product was dried with anhydrous sodium sulfate and the solvent was distilled off to a temperature of 115° C. under a reduced pressure.

A repeating number of the dimethylsilanoxy unit in PDMS with a phenol end group obtained was 30 as determined by NMR.

### Production Example 3

[Production of PC-PDMS Copolymer]

In 2 L of methylene chloride were dissolved 138 g of the reactive PDMS obtained in Production Example 2, with which 10 L of the PC oligomer obtained in Production Example 1 was further admixed. To this were added a solution dissolving 26 g of sodium hydroxide in 1 L of water and 5.7 cm³ of triethylamine, which was stirred at 500 rpm and reacted at room temperature for 1 hr.

After completing the reaction, a solution prepared by dissolving 600 g of bisphenol A in 5 L of a 5.2% by mass sodium hydroxide aqueous solution 8 L of methylene chloride, and 96 g of p-ert-butylphenol were added to the above reaction mixture which was stirred at 500 rpm and reacted at room temperature for 2 hrs.

After the reaction, 5 L of methylene chloride was added to the reaction mixture, which was then water-washed with 5 L of water, alkaline-washed with 5 L of a 0.03 mol/L sodium hydroxide aqueous solution, acid-washed with 5 L of a 0.2 mol/L hydrochloric acid, and water-washed with 5 L of water twice successively to finally remove methylene chloride to yield a flaky PC-PDMS copolymer. The PC-PDMS copolymer obtained was vacuum-dried at 120° C. for 24 hrs. The viscosity average molecular weight was 17,000 and the PDMS content was 3.0% by mass. Here, the viscosity average molecular weight and PDPS content were evaluated by the following methods.

(1) Viscosity Average Molecular Weight (Mv)

The viscosity of a methylene chloride solution at 20° C. was measured with an Ubbelohde viscometer to obtain the intrinsic viscosity of [η] to calculate Mv by the following equation
[η]=1.23×10⁻⁵Mv^{0.83}
(2) PDMS Content

A PDMS content was obtained based on the intensity ratio of the peaks, which appeared at 1.7 ppm for the methyl group of the isopropyl of bisphenol A and at 0.2 ppm for the methyl group of dimethylsiloxane in ¹H-NMR.

### Production Example 4-1

[Polycarbonate-Based Composition-1]

0.7 parts by mass of reactive polyorganosiloxane (trade name “BY16-161”, from Dow Corning Toray Co., Ltd.), 0.3 parts by mass of polytetrafluoroethylene (PTFE, trade name “CD076” from Asahi Glass Co., Ltd.), and 0.1 part by mass of triphenylphosphine (trade name “JC263” from Johoku Chemical Co., Ltd.) as an antioxidant were mixed with 100 parts by mass of a mixture consisting of 45% by mass of the polycarbonate-polyorganosiloxane copolymer (PC-PDMS, Mv=17,000, PDMS content=3.0% by mass) obtained in Production Example 3, 20% by mass of bisphenol A-type linear polycarbonate (“TAFLON FN1900A” from Idemitsu Kosan Co. Ltd., Mv=19,500), and 35% by mass of titanium oxide powder (trade name “PF740” from Ishihara Sangyo Kaisha, Ltd.; difference of moisture at 0° C. and 300° C. by Karl Fisher method=2600 ppm by mass) to melt-knead with a twin screw extruder to yield polycarbonate-based resin composition-1.

### Production Example 4-2

[Polycarbonate-Based Composition-2]

Polycarbonate-based composition-2 was prepared in a similar manner to polycarbonate-based composition-1, except bisphenol A-type branched polycarbonate (“TAFLON FB2500” from Idemitsu Kosan Co., Ltd., Mv=26,000) was used in place of the bisphenol A-type linear polycarbonate (“TAFLON FN1900A” from Idemitsu Kosan Co., Ltd., Mv=19,500).

### Production Example 4-3

[Polycarbonate-Based Composition-3]

0.8 parts by mass of reactive polyorganosiloxane (trade name “BY16-161” from Dow Corning Toray Co. Ltd.), 0.3 parts by mass of polytetrafluoroethylene (PTFE, trade name “CD076” from Asahi Glass Co., Ltd), and 0.1 part by mass of triphenylphosphine (trade name “JC263” from Johoku Chemical Co., Ltd.) as an antioxidant were mixed with 100 parts by mass of a mixture consisting of 40% by mass of the polycarbonate-polyorganosiloxane copolymer obtained in Production Example 3, 10% by mass of bisphenol A-type straight-chain polycarbonate (“TAFLON FN1900A” from Idemitsu Kosan Co., Ltd., Mv=19,500), and 50% by mass of titanium oxide powder (trade name “PF740” from Ishihara Sangyo Kaisha, Ltd., difference of moisture content at 100° C. and 300° C. by the Karl Fisher method=2600 ppm by mass) to melt-knead with a twin screw extruder to yield polycarbonate-based resin compositions.

### Production Example 4-4

[Polycarbonate-Based Composition-4]

1.6 parts by mass of reactive polyorganosiloxane (trade name “BY16-161” from Dow Corning Toray Co, Ltd.), 0.3 part by mass of polytetrafluoroethylene (PTFE, trade name “CD076” from Asahi Glass Co, Ltd.), and 0.1 part by mass of triphenylphosphine (trade name “JC263” from Johoku Chemical Co. Ltd.) as an antioxidant were mixed with 100 parts by mass of a mixture consisting of 30% by mass of the polycarbonate-polyorganosiloxane copolymer obtained in Production Example 3 and 70% by mass of titanium oxide powder (trade name “PF740” from Ishihara Sangyo Kaisha, Ltd., difference of moisture content at 100° C. and 300° C. by Karl Fisher method=2600 ppm by mass) to melt-knead with a twin screw extruder to yield polycarbonate-based resin composition-4.

### Production Example 4-5

[Polycarbonate-Based Composition-5]

1.5 parts by mass of reactive polyorganosiloxane (trade name “BY16-161” from Dow Corning Toray Co., Ltd.), 0.4 part by mass of polytetrafluoroethylene (PTFE, trade name “CD076” from Asahi Glass Co., Ltd.), and 0.1 part by mass of triphenylphosphine (“JC263” from Johoku Chemical Co., Ltd.) as an antioxidant were mixed with 100 parts by mass of a mixture consisting of 40% by mass of the polycarbonate-polyorganosiloxane copolymer obtained in Production Example 3 and 60% by mass of titanium oxide powder (trade name “PFC303” from Ishihara Sangyo Kaisha, Ltd., difference of moisture content at 100° C. and 300° C. by Karl Fisher method=1800 ppm by mass) to melt-knead with a twin screw extruder to yield polycarbonate-based resin composition-5.

### Production Example 4-6

[Polycarbonate-Based Composition-6]

1.4 parts by mass of reactive polyorganosiloxane (trade name “BY16-161” from Dow Corning Toray Co., Ltd.), 0.3 part by mass of polytetrafluoroethylene (PTFE, trade name “CD076” from Asahi Glass Co., Ltd.), and 0.1 part by mass of triphenylphosphine (trade name “JC263” from Johoku Chemical Co., Ltd.) as an antioxidant were mixed with 100 parts by mass of a mixture consisting of 50% by mass of the polycarbonate-polyorganosiloxane copolymer obtained in Production Example 3 and 50% by mass of titanium oxide powder (“PFC303” from Ishihara Sangyo Kaisha, Ltd., difference of moisture content at 100° C. and 300° C. by Karl Fisher method 1800 ppm by mass) to melt-knead with a twin screw extruder to yield polycarbonate-based resin compositions.

### Production Example 4-7

[Polycarbonate-Based Composition-7]

1.5 parts by mass of reactive polyorganosiloxane (trade name “BY16-161” from Dow Corning Toray Co., Ltd), 0.3 part by mass of polytetrafluoroethylene (PTFE, trade name “CD076” from Asahi Glass Co., Ltd), and 0.1 part by mass of triphenylphosphine (trade name “JC263” from Johoku Chemical Co., Ltd.) as an antioxidant were mixed with 100 parts by mass of a mixture consisting of 50% by mass of the polycarbonate-polyorganosiloxane copolymer obtained in Production Example 3, 20% by mass of titanium oxide powder (trade name “PFC303” from Ishihara Sangyo Kaisha, Ltd., difference of moisture content at 100° C. and 300° C. by Karl Fisher method 1800 ppm by mass), and 40% by mass of titanium oxide powder (trade name “PF726” from Ishihara Sangyo Kaisha, Ltd., difference of moisture content 100° C. and 300° C. by Karl Fisher method=5600 ppm by mass) to melt-knead with a twin screw extruder to yield polycarbonate-based resin composition-7.

### Production Example 4-8

[Polycarbonate-Based Composition-8]

2.5 parts by mass of reactive polyorganosiloxane (trade name “BY16-161” from Dow Corning Toray Co, Ltd), 0.3 part by mass of polytetrafluoroethylene (PTFE, trade name “CD076” from Asahi Glass Co., Ltd), and 0.1 part by mass of triphenylphosphine (trade name “JC263” from Johoku Chemical Co., Ltd.) as an antioxidant were mixed with 100 parts by mass of a mixture consisting of 30% by mass of bisphenol A-type linear polycarbonate (“TAFLON FN900A” from Idemitsu Kosan Co., Ltd., Mv=19,500) and 70% by mass of titanium oxide powder (trade name “PF726” from Ishihara Sangyo Kaisha, Ltd., difference of moisture content at 100° C. and 300° C. by Karl Fisher method=5600 ppm by mass) to melt-knead with a twin screw extruder to yield polycarbonate-based resin composition-8.

### Production Example 4-9

[Polycarbonate-Based Composition-9]

2.5 part by mass of reactive polyorganosiloxane (trade name “BY16-161” from Dow Corning Toray Co., Ltd.), 0.3 part by mass of polytetrafluoroethylene (PTFE, trade name “CD076” from Asahi Glass Co., Ltd.), and 0.1 part by mass of triphenylphosphine (trade name “JC263” from Johoku Chemical Co., Ltd.) as an antioxidant were mixed with 100 parts by mass of a mixture consisting of 50% by mass of bisphenol A-type linear polycarbonate (“TAFLON F900A” from Idemitsu Kosan Co., Ltd., Mv=19,500) and 50% by mass of titanium oxide powder (trade name “PF726” from Ishihara Sangyo Kaisha, Ltd., difference of moisture content at 100° C. and 300° C. by Karl Fisher method=5600 ppm by mass) to melt-knead with a twin screw extruder to yield polycarbonate-based resin composition-9.

### Production Example 5

[Production of Light-Shielding, Flame-Retardant Polycarbonate-Based Film for Sheet Lamination]

46% by mass of the polycarbonate-polyorganosiloxane copolymer obtained in Production Example 3, bisphenol A-type polycarbonate (“TAFLON A2600” from Idemitsu Kosan Co., Ltd., Mv=26,000), 5% by mass of carbon black (Mitsubishi Carbon MA-100 a black color material from Mitsubishi Chemical Corp.), and 0.3 part by mass of polytetrafluoroethylene (PTFE, trade name “CD076” from Asahi Glass Co., Ltd.) were melt-kneaded with a twin screw extruder to yield a polycarbonate-based resin composition. A film with 50 μm in thickness was prepared from the resulting light-shielding flame-retardant resin composition by cast molding. The film had a total light transmittance of 0.0%.

### Example 1

Polycarbonate-based composition-1 (pellet) was dried in a hot-air oven at 140° C. for 4 hrs. This material was extruded in a horizontal direction with a single screw extruder 65 mm in diameter equipped with a devolatilizer, a gear pump, and a coat-hanger die 60 cm in width to fabricate a sheet 0.5 mm thick with a vertically stacked three chill roll system. Herein, the cylinder temperature was 250 to 260° C., the devolatilizing pressure was 1.3 kPa-Hg, the die temperature was 240° C., the roll temperatures were 120/150/170° C. in an order of roll 1/2/3 and the extrusion rate was 30 kg/hr. The properties of the resulting sheet are shown in Table 1.

### Example 2

The similar procedure to Example 1 was carried out except that polycarbonate-based composition-2 was used to and that the take-up rates of sheets were adjusted to obtain 1 mm thick sheet and 0.1 nm thick sheet.

### Example 3

The similar procedure to Example 1 was carried out except polycarbonate-based composition-3 was used.

### Example 4

The similar procedure to Example 1 was carried out except polycarbonate-based composition-4 was used.

### Example 5

The similar procedure to Example 1 was carried out except polycarbonate-based composition-5 was used.

### Example 6

When polycarbonate-based composition-5 was molded into a sheet, the light-shielding flame-retardant polycarbonate-based film for sheet lamination obtained in Production Example 5 was fed between a No.2 roll and a melted web to thermally laminate with the nip pressure to yield a laminated sheet.

### Example 7

The similar procedure to Example 1 was carried out except polycarbonate-based composition-6 was used.

### Example 8

The similar procedure to Example 1 was carried out except polycarbonate-based composition-7 was used.

### Comparative Example 1

The similar procedure to Example 1 was carried out except polycarbonate-based composition-8 was used.

### Comparative Example 2

The similar procedure to Example 1 was carried out except polycarbonate-based composition-9 was used.

TABLE 1
Table 1

| | | | | | Moisture | | | | | | | |
|---|---|---|---|---|---|---|---|---|---|---|---|---|
| | Titanium | | | | concentration | Moisture | | | | | | |
| | oxide species | | | | difference | content of | | | | | | |
| | Moisture | | | | derived from | PC resin | | | | | | |
| | concentration | PF740 | PFC303 | PF726 | titanium | compositions | | | | | | |
| | difference of | 2800 | 1800 | 5600 | oxides in PC | before | | | | | | |
| Examples, | titanium | Mixed amounts of various | | | resin | molding and | | Sheet | Light | Light | V-0 | Total |
| Comparative | oxides | titanium oxides | | | compositions | after drying | Mold- | thickness | reflect- | transmit- | Burning | judg- |
| Examples | Compositions | (% by mass) | | | (ppm) | (ppm) | ability | (mm) | ance | tance | Test | ment |
| Example 1 | Composition-1 | 35 | 0 | 0 | 910 | 960 | ◯ | 0.5 | 99.1 | 0.8 | Passed | ◯ |
| Example 2 | Composition-2 | 0 | 35 | 0 | 630 | 680 | ◯ | 0.5 | 99.4 | 0.8 | Passed | ◯ |
| Example 3 | Composition-3 | 50 | 0 | 0 | 1300 | 1350 | ◯ | 0.5 | 99.3 | 0.3 | Passed | ◯ |
| Example 4 | Composition-4 | 70 | 0 | 0 | 1820 | 1870 | ◯ | 0.5 | 99.2 | 0.1 | Passed | ◯ |
| Example 5 | Composition-5 | 0 | 60 | 0 | 1080 | 1130 | ◯ | 0.2 | 99.3 | <0.1 | Passed | ◯ |
| Example 6 | Composition-5 | 0 | 60 | 0 | 1080 | 1130 | ◯ | Reflecting | 99.3 | 0.0 | Passed | ◯ |
| | | | | | | | | layer 0.2/ | | | | |
| | | | | | | | | Shielding | | | | |
| | | | | | | | | layer 0.1 | | | | |
| Example 7 | Composition-6 | 0 | 50 | 0 | 900 | 950 | ◯ | 0.5 | 99.6 | 0.3 | Passed | ◯ |
| Example 8 | Composition-7 | 0 | 20 | 40 | 2600 | 2650 | | 0.5 | 99.0 | 0.1 | Passed | ◯ |
| Comparative | Composition-8 | 0 | 0 | 10 | 3920 | 3970 | X | 0.5 | 97.2 | <0.1 | Failed | X |
| Example 1 | | | | | | | | | | | | |
| Comparative | Composition-9 | 0 | 0 | 50 | 2800 | 2860 | Δ | 0.5 | 97.8 | 0.3 | Failed | X |
| Example 2 | | | | | | | | | | | | |

*Moldability judgment: ◯/having neither surface roughness (voids, blisters) nor poor color tone. Δ/having slight surface roughness (voids, blisters) and poor color tone. X/having both surface roughness (voids, blisters) and poor color tone.
(Note)
Moisture concentration difference of titanium oxide: Differences in the moisture concentrations between 100° C. and 300° C. in the Karl Fisher's method, of which the measurement method is as described in the body of the present specification.

### Example 9

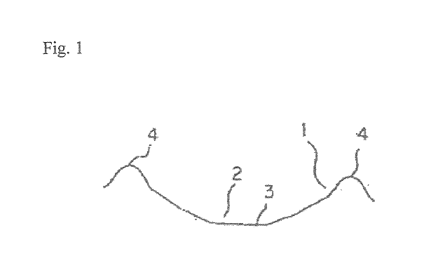

The sheet prepared in Example 7 was used to thermoform a shaped article of a light-reflecting panel used in direct-underlying backlight (for example, refer to Japanese Patent Laid-Open Publication No. 2002-32029). A partial longitudinal sectional view of the light-reflecting plane in the shaped article of the light-reflecting panel is shown in FIG. 1.

The sheet was dried at 140° C. for 5 hr and vacuum-formed with a FK-0431-10 thermoformer from Asano Laboratories Co., Ltd. after heating the sheet surface temperature to 180° C. and using an A1 die at an average draw ratio of 1.3.

In FIG. 1, light-reflecting panel 1 has a curved section 4 at both ends and a light-source accommodating groove 2 at the center while the light-reflecting plane has a multicurve 3.

The resulting light-reflecting panel was loaded on a commercial 15 inch direct-underlying backlight unit and the luminance was measured with LS-110 from Minolta Camera. Inc. In addition, whether the light from the light-source was leaked through the rear face of the light-reflecting panel was visually confirmed.

### Comparative Example 4

The similar procedure to Example 9 was carried out except the sheet prepared in Comparative Example 1 was used.

### Comparative Example 5

The similar procedure to Example 9 was carried out except the sheet prepared in Comparative Example 3 was used.

Each evaluation result is shown in Table 2.

TABLE 2
Table 2

| | | | | Leak of light |
|---|---|---|---|---|
| Examples | | | | from |
| and | | | | light-source |
| Comparative | | | Luminance | (visual |
| Examples | Composition | Sheet | (cd/m²) | assessment) |
| Example 9 | Composition-6 | Example 7 | 5916 | No leak |
| Comparative | Composition-8 | Comparative | 5412 | Slight leak |
| Example 4 | | Example 1 | | |
| Comparative | Composition- | Comparative | 5622 | Leak |
| Example 5 | 10 | Example 3 | | |

### INDUSTRIAL APPLICABILITY.

The light-reflecting sheet of the present invention has a light reflectance of 99% or more, a light transmittance of less than 1%, a V-0 class flame retardancy at a thickness of 0.6 mm in the UL94 Vertical Burning Test, and thermoformability and can provide a light box with high luminance and no irregularity by thermoforming said light-reflecting sheet, wherein a shape is easily designed in accordance with the types and the number of light-sources.

The present art can be applied to displays such as liquid crystal backlights and others, lighting fixtures, and light-reflecting parts of a light-source such as a fluorescent lamp for housing, equipments, etc., LED, EL, plasma, laser and others.

1-9. (canceled)

10. A light-reflecting sheet formed from a polycarbonate resin composition which contains a combination of 70 to 30% by mass of a polycarbonate-based polymer (A) and 30% to 70 by mass of titanium oxide (B) having a difference of moisture concentration at 100° C. with that at 300° C. determined by the Karl Fisher's method of 2700 ppm by mass or less.

11. The light-reflecting sheet according to claim 10, wherein the above polycarbonate resin composition further contains 0 to 1.0 part by mass of polytetrafluoroethylene (C) capable of forming fibrils and 0.01 to 5.0 parts by mass of a reactive polyorganosiloxane (D) with respect to 100 parts by mass of said resin composition.

12. The light-reflecting sheet according to claim 10, wherein the polycarbonate resin composition used in molding has a moisture concentration of 2850 ppm by mass or less.

13. The light-reflecting sheet according to claim 11, wherein the pol carbonate resin composition used in molding has a moisture concentration of 2850 ppm by mass or less.

14. The light-reflecting sheet according to claim 10, wherein the 300° C. determined by the Karl Fisher's method in the above polycarbonate resin composition is 2700 ppm by mass or less.

15. The light-reflecting sheet according to claim 10, having a thickness of 0.1 to 1 mm, a light reflectance of 99% or more, and a light transmittance of less than 1%.

16. The light-reflecting sheet according to claim 10, having a V-0 class flame retardancy at a thickness of 0.6 nm in the Vertical Burning Test complying with the UL94 method.

17. The light-reflecting sheet according to claim 10, wherein the surface of titanium oxide (B) particle has a coating layer formed with surface treatment agents selected from a combination of any two or more of a hydrated oxide of aluminum and/or silicon, a phosphoric acid compound or its hydrate, a hydrolysate of an organosilane compound, and a reactive polyorganosiloxane.

18. The light-reflecting sheet according to claim 10, wherein a light-shielding layer is formed on the rear face thereof.

19. A shaped article which is formed by heating the light-reflecting sheet described in claim 10 at 160° C. to 200° C., followed by thermoforming a draw ratio of 1.1 to 2.
